(19) United States
(12) Patent Application Publication
(10) Pub. No.: US 2013/0147433 A1
(43) Pub. Date: Jun. 13, 2013

(54) METHOD OF CONTROLLING THE POWER STATUS OF A BATTERY PACK AND RELATED SMART BATTERY DEVICE

(71) Applicants: Chun-Ming Chen, Hsinchu City (TW); Chang-Fu Hsia, Taichung City (TW)

(72) Inventors: Chun-Ming Chen, Hsinchu City (TW); Chang-Fu Hsia, Taichung City (TW)

(73) Assignee: POWERFLASH TECHNOLOGY CORPORATION, Hsinchu (TW)

(21) Appl. No.: 13/418,357

(22) Filed: Mar. 13, 2012

Related U.S. Application Data
(60) Provisional application No. 61/569,760, filed on Dec. 12, 2011.

(51) Int. Cl. H02J 7/00

(52) U.S. Cl. 320/112; 320/162; 320/116; 320/134

(57) ABSTRACT

In a smart battery device, a battery pack having a plurality of battery cells is provided. During charging, if the voltage of each battery cell does not exceed the maximum operational voltage associated with individual battery cell, the battery pack is charged by a first voltage. If the voltage of any battery cell is not smaller than the maximum operational voltage associated with individual battery cell, the battery pack is charged by a second voltage smaller than the first voltage.

### CROSS REFERENCE TO RELATED APPLICATIONS

This application claims the benefit of the filing date of U.S. provisional patent application No. 61/569,760, filed Dec. 12, 2011, the contents of which are hereby incorporated by reference.

### BACKGROUND OF THE INVENTION

1. Field of the Invention

The present invention is related to a method of controlling a power status of a battery pack and a related smart battery device, and more particularly, to a method of controlling a power status of a battery pack and a related smart battery device with increased lifetime.

2. Description of the Prior Art

Mobile devices such as personal digital assistants (PDAs), digital cameras, portable media players and laptop/flat panel computers have become more and more popular. In order to provide portability, these mobile devices are normally powered by rechargeable batteries. A rechargeable battery may be charged via a specialized charger, or by connecting the mobile device to AC mains. Due to limited capacity of an individual battery cell, a battery pack including a plurality of battery cells is commonly used in electronic devices, such as laptop computers.

Battery lifetime is the elapsed time before a rechargeable battery becomes unusable whether it is in active use (repetitively being charged and discharged) or inactive. There are two key factors influencing battery lifetime, namely the physical characteristics of the battery cell and the charging method. Generally speaking, a higher charging current/voltage shortens the required charging time, but also reduces the battery lifetime. Over-charging or over-discharging may utilize more battery capacity, but also reduces the battery lifetime. Therefore, battery manufacturers generally provide a maximum operational voltage and a minimum operational voltage in the product specification.

FIG. 1 is a diagram illustrating a prior art method of charging a battery pack. The curves in FIG. 1 depict the relationship between the charging voltage and the charging time of the battery pack in the prior art. For illustrative purpose, assume that the prior art battery pack includes three battery cells C1-C3 connected in series. V_{C1}-V_{C3} represent the voltages established across the battery cells C1-C3, respectively. V_{PACK}_{_{—}}_{MAX} represents the maximum operational voltage of the battery pack, and V_{PACK}_{_{—}}_{MIN} represents the minimum operational voltage of the battery pack. V_{CELL}_{_{—}}_{MAX} represents the maximum operational voltage of individual battery cell, and V_{CELL}_{_{—}}_{MIN} represents the minimum operational voltage of individual battery cell. V_{PACK} represents the voltage established across the battery pack and is equal to (V_{C1}+V_{C2}+V_{C3}). As illustrated in FIG. 1, the charging period of the battery pack includes a constant-current period Tᵢ and a constant-voltage period T_{V}. During the constant-current period Tᵢ, the charger is configured to supply a constant charging current, and the voltage V_{PACK} established across the battery pack remains lower than a constant charging voltage V_{CHG} which does not influence to voltage of the charger. When the voltage V_{PACK} reaches the constant charging voltage V_{CHG}, the charger enters the constant-voltage period T_{V} for supplying the constant charging voltage V_{CHG} until the charging period ends. In the prior art, V_{CHG} is generally set to V_{PACK}_{_{—}}_{MAX} which is equal to V_{CELL}_{_{—}}_{MAX} multiplied by the number of the battery cells connected in series. For example, V_{PACK}_{_{—}}_{MAX} is equal to 3*V_{CELL}_{_{—}}_{MAX} when the battery pack includes three battery cells connected in series.

FIG. 2 is a diagram illustrating a prior art method of discharging a battery pack. The curves in FIG. 2 depict the relationship between the discharging voltage and the discharging time of the battery pack in the prior art. In order to prevent the battery pack from being over-discharged, the discharging of the battery pack ends when the voltage V_{PACK} drops to V_{PACK}_{_{—}}_{MIN}, which is equal to V_{CELL}_{_{—}}_{MIN} multiplied by the number of the battery cells connected in series. For example, V_{PACK}_{_{—}}_{MIN} is equal to 3*V_{CELL}_{_{—}}_{MIN} when the battery pack includes three battery cells connected in series.

For better power efficiency, a battery pack preferably includes a plurality of battery cells with similar physical characteristics. However, the physical characteristics and deterioration rate of each battery cell in the battery pack may still vary due to process variations. Therefore, the differences among the charging/discharging characteristics of individual battery cells grow larger as the battery pack is in active use over time. The initial recommended voltages V_{PACK}_{_{—}}_{MAX} and V_{PACK}_{_{—}}_{MIN} may eventually fail to prevent the battery pack from being over-charged/discharged.

For example, the voltage V_{C1} may exceed the maximum operational voltage V_{CELL}_{_{—}}_{MAX} due to the differences among the charging characteristics of the battery cells C1-C3 . In other words, the prior art battery cell C1 is over-charged during the constant-voltage period T_{V}, as depicted in FIG. 1. At T1 during the discharging period, the voltage V_{C1} may drop below the minimum operational voltage V_{CELL}_{_{—}}_{MIN} due to the differences among the discharging characteristics of the battery cells C1-C3. In other words, the prior art battery cell C1 is over-discharged between T1 and T2 during the discharging period, as depicted in FIG. 2. After a while, different charging/discharging states increase the characteristic difference among individual battery cells, which causes the battery cell with the smallest capacity to fail in advance. Even if other battery cells with larger capacity still function normally, the overall performance and lifetime of the battery pack may still be greatly influenced.

In one prior art battery pack, each battery cell is provided with a parallel balancing circuit. The parallel circuit may prevent a corresponding battery cell from entering over-charged state after being fully-charged by converting extra energy into thermal energy. Such prior art battery pack requires extra balancing circuits which increase circuit complexity and component cost.

In another prior art battery pack, a lower charging current is used for reducing the deterioration rate of the battery cells. However, such prior art fails to work for a battery pack with serial configuration since each of the plurality of battery cells may still be over-charged/discharged when connected in series.

### SUMMARY OF THE INVENTION

The present invention provides a method of controlling a power status of a battery pack. The method includes measuring voltages established across a plurality of battery cells in the battery pack, respectively; charging the battery pack by a first voltage if the voltage of each battery cell is not larger than a maximum operational voltage associated with an individual battery cell; and charging the battery pack by a second voltage smaller than a first voltage if the voltage of any battery cell is not smaller than the maximum operational voltage associated with the individual battery cell.

The present invention also provides a smart battery device which includes a battery pack including a plurality of battery cells and a battery management integrated circuit which is configured to measure voltages established across the plurality of battery cells and control a smart charger accordingly. The smart charger is configured to charge the battery pack by a first voltage if the voltage established across each battery cell is not larger than a maximum operational voltage associated with an individual battery. The smart charger is configured to charge the battery pack by a second voltage smaller than the first voltage if the voltage established across any battery cell is not smaller than the maximum operational voltage associated with the individual battery.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a prior art method of charging a battery pack.

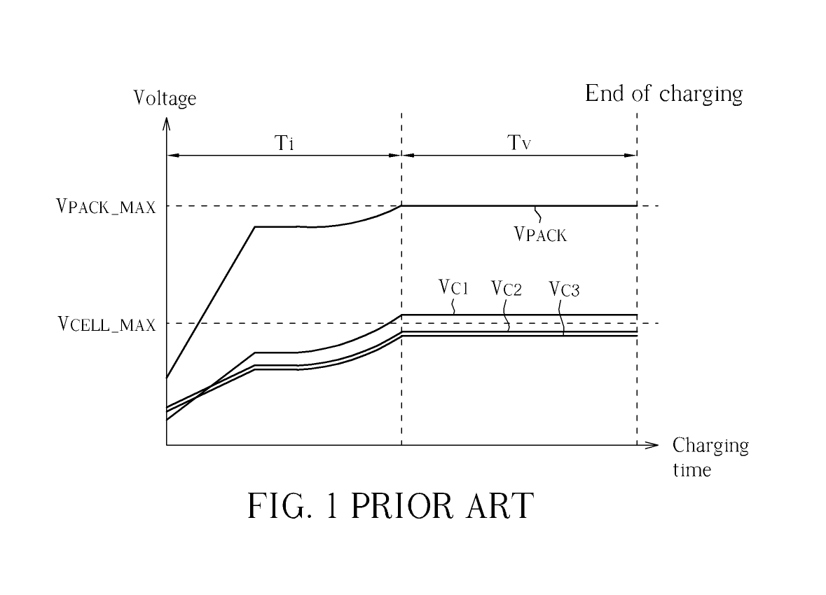

FIG. 2 is a diagram illustrating a prior art method of discharging a battery pack.

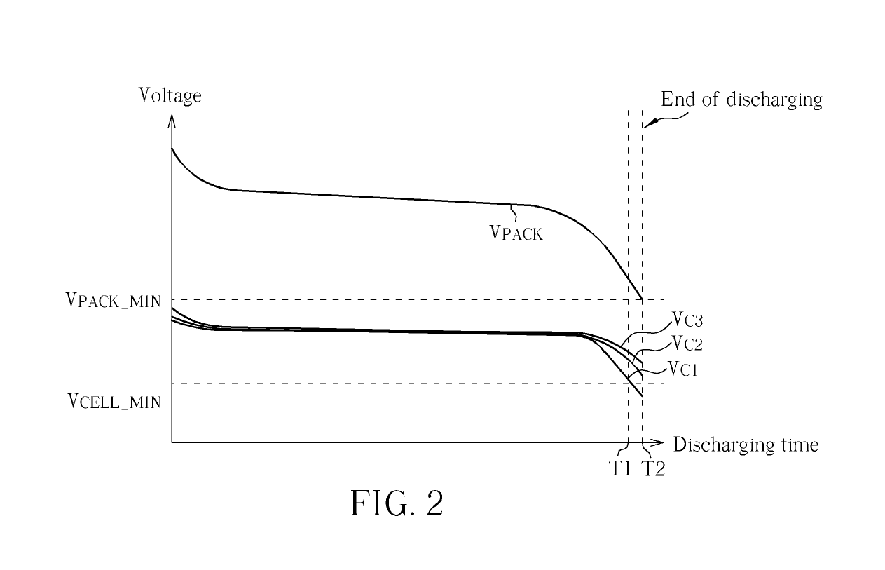

FIG. 3 is a functional diagram illustrating a smart battery device according to the present invention.

FIG. 4 is a flowchart illustrating a method of controlling the power status of the battery pack according to the present invention.

FIG. 5 is a diagram illustrating the relationship between the charging voltage and the charging time of the battery pack according to the present invention.

FIG. 6 is a diagram illustrating the relationship between the discharging voltage and the discharging time of the battery pack according to the present invention.

### DETAILED DESCRIPTION

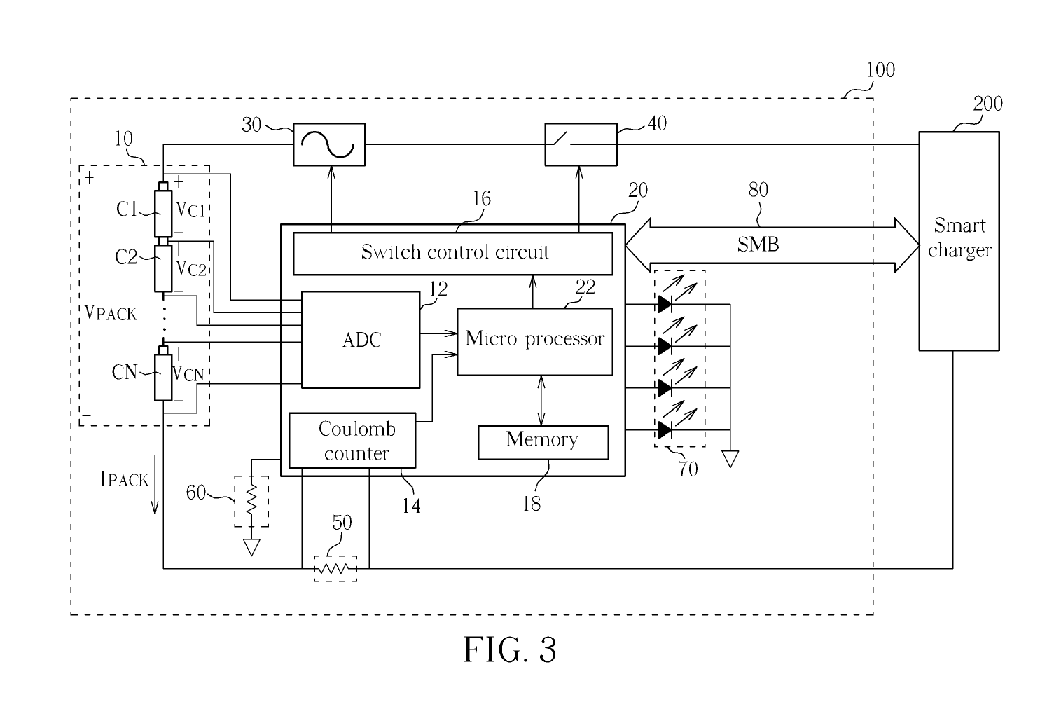

FIG. 3 is a functional diagram illustrating a smart battery device 100 according to the present invention. The smart battery device 100 includes a battery pack 10, a battery management integrated circuit 20, a fuse 30, a switch 40, a current sensing resistor 50, a thermistor 60, a display unit 70, and a system management bus (SMB) 80.

The battery pack 10 includes a plurality of battery cells C1-CN which may be configured in parallel, series or a mixture of both for delivering the desired voltage, capacity, or power density to electronic devices. FIG. 3 depicts an embodiment of a serial configuration. V_{PACK} represents the overall voltage established across the battery pack 10. V_{C1}-V_{CN} represent the voltages established across the battery cells C1-CN, respectively. I_{PACK} represents the current flowing through the battery pack 10. The positive terminal of the battery pack 10 may be electrically connected to a smart charger 200 via the fuse 30 and the switch 40. The negative terminal of the battery pack 10 may be electrically connected to the smart charger 200 via the current sensing resistor 50.

The battery management integrated circuit 20 includes an analog-to-digital converter (ADC) 12, a Coulomb counter 14, a switch control circuit 16, a memory 18, and a micro-processor 22. The ADC 12 is configured to monitor the voltages V_{C1}-V_{CN} respectively established across the battery cells C1-CN and the voltage established across the thermistor 60 (associated with the temperature of the battery pack 10). The Coulomb counter 14 is configured to monitor the voltage established across the current sensing resistor 50 (associated with the current I_{PACK} of the battery pack 10). Therefore, the micro-processor 22 may control the operation of the switch control circuit 16 accordingly. The switch control circuit 16 is configured to control the fuse 30 and the switch 40 in order to prevent sudden over-current, over-voltage or over-temperature from damaging the battery pack 10. Meanwhile, the battery management integrated circuit 20 may provide battery pack information (such as voltage, current, temperature or capacity) via the SMB 80 so that the smart charger 200 may adjust its output accordingly. The memory 18 may be used for storing the charging characteristics, usage history, firmware and database of the battery pack 10. The display unit 70 may include a plurality of light-emitting diodes for displaying the capacity or status of the battery pack 10.

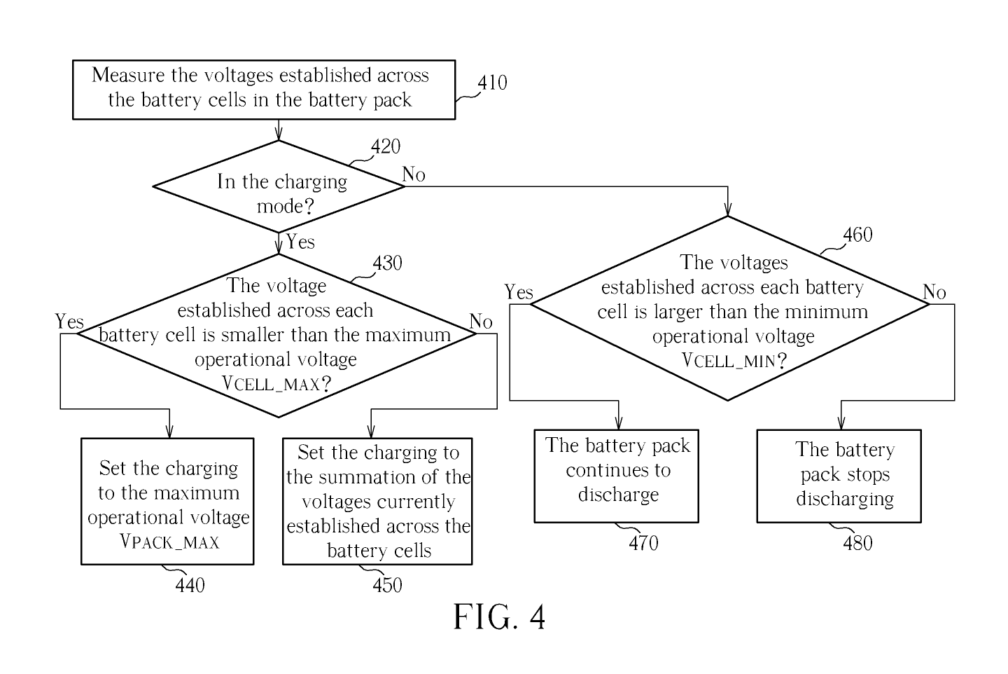

FIG. 4 is a flowchart illustrating a method of controlling the power status of the battery pack 10 and including the following steps:

Step 410: measure the voltages V_{C1}-V_{CN} established across the battery cells C1-CN in the battery pack 10.

Step 420: determine if the battery pack 10 is in the charging mode: if yes, execute step 430; if no, execute step 460.

Step 430: determine if each of the voltages V_{C1}-V_{CN} is smaller than the maximum operational voltage V_{CELL}_{_{—}}_{MAX}: if yes, execute step 440; if no, execute step 450.

Step 440: set the charging voltage of the smart charger 200 to the maximum operational voltage V_{PACK}_{_{—}}_{MAX}.

Step 450: set the charging voltage of the smart charger 200 to the summation of the current voltages V_{C1}-V_{CN}.

Step 460: determine if each of the voltages V_{C1}-V_{CN} is larger than the minimum operational voltage V_{CELL}_{_{—}}_{MIN}: if yes, execute step 470; if no, execute step 480.

Step 470: short-circuit the switch 40 for allowing the battery pack to discharge.

Step 480: open-circuit the switch 40 for preventing the battery pack from discharging.

The above steps in the present method may be performed periodically (such as every other second) in the battery management integrated circuit 20, the smart charger 200, or another host connected to the SMB 80. First, the voltages V_{C1}-V_{CN} established across the battery cells C1-CN are measured in step 410. Next, it is determined if the battery pack 10 is currently being charged.

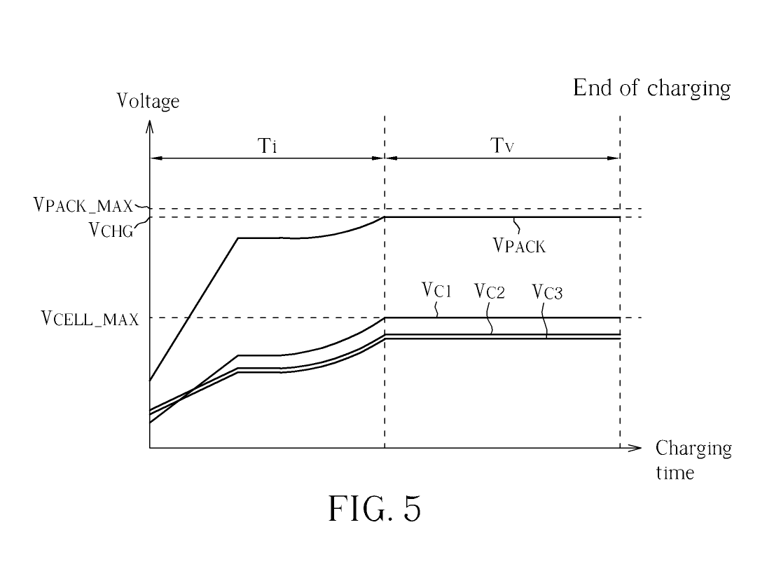

When the battery pack 10 is in the charging mode, steps 430, 440 or 450 of the present method are executed. FIG. 5 is a diagram illustrating the relationship between the charging voltage and the charging time of the battery pack 10 according to the present invention. For illustrative purpose, assume that the battery pack 10 of the present invention includes three battery cells C1-C3 connected in series. The charging period of the battery pack 10 includes a constant-current period Tᵢ and a constant-voltage period T_{V}. V_{PACK}_{_{—}}_{MAX} represents the maximum operational voltage of the battery pack 10, and V_{PACK}_{_{—}}_{MIN} represents the minimum operational voltage of the battery pack 10. V_{CELL}_{_{—}}_{MAX} represents the maximum operational voltage of an individual battery cell, and V_{CELL}_{_{—}}_{MIN} represents the minimum operational voltage of an individual battery cell.

During the constant-current period Tᵢ, the smart charger 200 is configured to supply a constant charging current I_{PACK}, or adjust its output current according to the information received from the battery management integrated circuit 20 via the SMB 80. During this period, the voltages V_{PACK} and V_{C1}-V_{C3} gradually increase with time.

When one of the voltages V_{C1}-V_{C3} reaches the maximum operational voltage V_{CELL}_{_{—}}_{MAX}, V_{PACK} is equal to (V_{C1}+V_{C2}+ . . . +V_{CN}) and the constant-voltage period Tᵢ begins. The smart charger 200 is configured to supply a constant charging voltage V_{CHG}, which is equal to the summation of the current battery cell voltages V_{C1}-V_{CN}, until the constant-voltage period Tᵢ ends. During this period, the voltage V_{PACK} established across the battery pack 10 is equal to V_{CHG} and V_{PACK}≦V_{PACK}_{_{—}}_{MAX}, as depicted in FIG. 5. Therefore, the present invention may prevent the battery cell C1 from being over-charged, thereby increasing the lifetime of the battery pack 10.

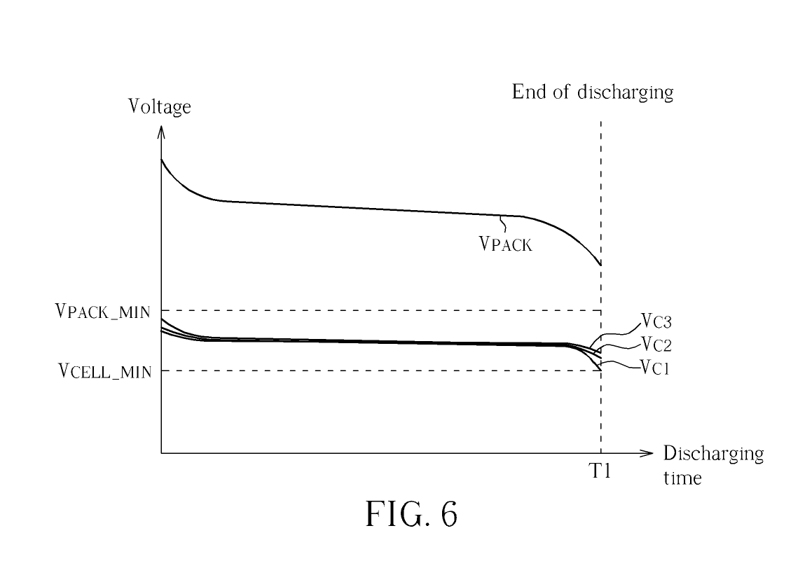

When the battery pack 10 is not in the charging mode, step 460 of the present method is executed. FIG. 6 is a diagram illustrating the relationship between the discharging voltage and the discharging time of the battery pack 10 according to the present invention. When one of the voltages V_{C1}-V_{C3} drops to the minimum operational voltage V_{CELL}_{_{—}}_{MIN}, step 480 is executed to prevent the battery pack 10 from further discharging, as depicted in FIG. 6. For example, the battery management integrated circuit 20 may block the discharging path of the battery pack 10 by open-circuiting the switch 40. Therefore, the present invention may prevent the battery cell C1 from being over-discharged, thereby increasing the lifetime of the battery pack 10.

In conclusion, the present invention may prevent all battery cells in the battery pack 10 from being over-charged/discharged, thereby increasing the lifetime of the battery pack 10.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of controlling a power status of a battery pack, comprising:
measuring voltages established across a plurality of battery cells in the battery pack, respectively;
charging the battery pack by a first voltage if the voltage of each battery cell is not larger than a maximum operational voltage associated with an individual battery cell; and
charging the battery pack by a second voltage smaller than a first voltage if the voltage of any battery cell is not smaller than the maximum operational voltage associated with the individual battery cell.

2. The method of claim 1, wherein the first voltage is a maximum operational voltage of the battery pack and the second voltage is a summation of the voltages established across all battery cells connected in series in the battery pack when the voltage of any battery cell is not smaller than the maximum operational voltage associated with the individual battery cell.

3. The method of claim 1, further comprising:
discharging the battery pack if the voltage established across each battery cell is larger than a minimum operational voltage associated with the individual battery cell; and
stopping discharging the battery pack if the voltage established across any battery cell is not larger than the minimum operational voltage associated with the individual battery cell.

4. A smart battery device, comprising:
a battery pack including a plurality of battery cells; and
a battery management integrated circuit configured to measure voltages established across the plurality of battery cells and control a smart charger accordingly, wherein:
the smart charger is configured to charge the battery pack by a first voltage if the voltage established across each battery cell is not larger than a maximum operational voltage associated with an individual battery; and
the smart charger is configured to charge the battery pack by a second voltage smaller than the first voltage if the voltage established across any battery cell is not smaller than the maximum operational voltage associated with the individual battery.

5. The smart battery device of claim 4, wherein the first voltage is a maximum operational voltage of the battery pack and the second voltage is a summation of the voltages established across all battery cells connected in series in the battery pack when the voltage of any battery cell is not smaller than the maximum operational voltage associated with the individual battery cell.

6. The smart battery device of claim 4, wherein the battery management integrated circuit is further configured to block a discharging path of the battery pack if the voltage established across any battery cell is not larger than a minimum operational voltage associated with the individual battery cell.

7. The smart battery device of claim 4, further comprising:
a switch or a fuse disposed between the battery pack and the smart charger;
a current sensing resistor disposed between the battery pack and the smart charger for detecting a current flowing through the battery pack; and
a thermistor for detecting a temperature of the battery pack.

8. The smart battery device of claim 7, wherein the battery management integrated circuit further comprises:
an analog-to-digital converter configured to detect the voltages established across the battery cells and the voltage established across the thermistor;
a Coulomb counter configured to detect a voltage established across the current sensing resistor;
a switch control circuit configured to control the fuse or the switch for preventing a sudden over-current, a sudden over-voltage, or a sudden over-temperature from damaging the battery pack; and
a micro-processor configured to analyze information gathered by the analog-to-digital converter and the Coulomb counter for controlling the switch control circuit accordingly.

9. The smart battery device of claim 7, wherein the switch control circuit is further configured to control the fuse or the switch according to the voltage established across the thermistor, the voltage established across the current sensing resistor, the voltage established across battery pack, or the voltages established across the plurality of battery cells.

10. The smart battery device of claim 4, further comprising a system management bus disposed between the battery management integrated circuit and the smart charger.
